(19) United States
(12) Patent Application Publication
(10) Pub. No.: US 2006/0200450 A1
(43) Pub. Date: Sep. 7, 2006

(54) Monitoring health of actively executing computer applications

(75) Inventors: Thomas W. Keane, Seattle, WA (US); Anand Lakshminarayanan, Redmond, WA (US); Mark E. Roseberry, Seattle, WA (US); Stephen O. Wilson, Redmond, WA (US); Baelson B. Duque, Redmond, WA (US); Chris W. Hallum, Redmond, WA (US); Robert T. Hutchison, Snoqualmie, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/071,937

(22) Filed: Mar. 4, 2005

(51) Int. Cl. G06F 17/30

(52) U.S. Cl. 707/3

(57) ABSTRACT

Systems and methods are described that monitor health of actively executing computer applications, and particularly which monitor relational database space availability. In one implementation, a warning threshold is defined for free space within a database located on a SQL server. The complexity of the database is assessed, in part by locating each file within the database. A health state is then established for each of the files located within the database, wherein the health state is based on a comparison of free space in each of the located files to the warning threshold.

### TECHNICAL FIELD

The present disclosure generally relates to systems and methods for monitoring health of actively executing computer applications, and more particularly to SQL server monitoring, Internet information services monitoring, server monitoring, vulnerability and security update analysis monitoring, SQL database free space monitoring, long running agent job monitoring, blocked server processes monitoring, and to related topics.

### BACKGROUND

Ensuring that the health of applications based on Windows® and other systems can be easily monitored has become increasingly crucial, particularly as businesses have increasingly based their mission-critical applications on Windows®-based systems. Some of the key challenges facing computer systems administrators today include how to manage the health of key applications. Such applications include Microsoft® SQL Server 2000, a very complex relational database; Windows® Internet Information Services, upon which web front ends are built; and crucial operational aspects of the Windows® operating system. It is additionally important to support systems administrators to ensure that servers are deployed securely with regard to security updates and best practice configuration standards.

Monitoring the health of a SQL server, such as Microsoft® SQL Server 2000, can be difficult for some monitoring systems due, for example, to the large list of components that make up Microsoft® SQL Server 2000 and the wide range of configurable options for each of these. Many software customers have different configurations of Microsoft® SQL Server 2000 and may have intermixed configurations of SQL Server, where they are running multiple versions, multiple instances or different stock keeping units (SKUs) on a single computer. In such instances, the task of monitoring SQL Server is significantly more complex. For example, a customer can run Microsoft® SQL Server version 7.0 in a version switch configuration with Microsoft® SQL Server 2000. Furthermore, this customer may also be running a copy (or multiple copies) of Microsoft® Data Engine (MSDE) on the same computer that appears at first glance very similar to SQL Server Enterprise Edition. Accordingly, monitoring this customer's application would be difficult.

There are many elements to monitoring basic health of an operating system, but one of the most fundamental is to understand when a given server or set of servers is bottlenecked on physical resources. Although there are many causes of bottlenecking, the most common resource bottleneck is related to the amount of processing cycles available to services running on the server. A significant complication has arisen in recent years where servers are designed to use all available processing resources without affecting the performance of the principle functions that the server is expected to perform. This may be accomplished by employing resource-throttling techniques that can be as simple a thread pools running at lower than normal thread priority. In these cases, looking solely at the processing utilization may not give a full picture of cycles available to the principle server functions, and thus more sophisticated algorithms may be required.

Another area that systems administrators should monitor is related to tracking the security posture of various types of servers. In a manner similar to many software applications, those running on servers may be prone to security vulnerabilities. These vulnerabilities may be related to the underlying platform (i.e. the OS), or related to user inexperience with management and maintenance of the application. Currently, a common way to alert users about vulnerabilities in the software that are due to software defects or flaws in the design is some form of public disclosure or bulletin. Microsoft® alerts users to problems through a document, mssecure.xml, that is easily downloadable over the Internet. However, this provision leaves the burden on the user to distribute and/or leverage the download in their distributed environment, and to determine the overall security posture of their applications and servers.

Accordingly, a need exists for a more complete solution to monitoring health of actively executing computer applications.

### SUMMARY

Systems and methods are described that monitor health of actively executing computer applications, and particularly which monitor relational database space availability. In one implementation, a warning threshold is defined for free space within a database located on a SQL server. The complexity of the database is assessed, in part by locating each file within the database. A health state is then established for each of the files located within the database, wherein the health state is based on a comparison of free space in each of the located files to the warning threshold.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical items.

FIG. 1 illustrates exemplary aspects of remote and local monitoring of an operating SQL database.

FIGS. 2A and 2B illustrate an exemplary health checks performed on a SQL server.

FIG. 3 illustrates an example of a work flow associated with a remote health check.

FIG. 4 illustrates an example of a multilayered approach to monitoring a web application platform and applications hosted on the platform.

FIGS. 5A and 5B illustrate exemplary aspects associated with web platform and application and Internet information services monitoring.

FIG. 6 illustrates an example of processor (CPU) performance threshold monitoring.

FIG. 7 illustrates an example of processor (CPU) performance health monitoring.

FIG. 8 illustrates an example of installation of a security-scanning engine, distribution of a security manifest and asynchronous scanning.

FIGS. 9A and 9B illustrate an example of vulnerability and security update analysis, particularly in a distributed environment.

FIG. 10 illustrates an example of monitoring relational database free space.

FIGS. 11A and 11B illustrate an example of relational database free space monitoring.

FIGS. 12A and 12B illustrate an example of long running agent jobs on a SQL server and how they can be monitored.

FIG. 13 illustrates an example of blocking server process IDs.

FIG. 14 illustrates an example wherein a security manifest is distributed.

FIG. 15 illustrates an example of an interchangeable security-scanning engine, configured to allow update to a newer and more compatible scanning engine.

FIG. 16 illustrates an exemplary process that monitors health of actively executing computer applications, and particularly addresses issues of relational database free space monitoring.

FIG. 17 illustrates an exemplary method that monitors health of actively executing computer applications, and particularly addresses issues related to monitoring a SQL server.

FIG. 18 illustrates an exemplary method for monitoring health of actively executing computer applications, and particularly addresses monitoring of Internet information services.

FIG. 19 illustrates an exemplary computing environment suitable for monitoring health of actively executing computer applications.

### DETAILED DESCRIPTION

Overview

The following discussion is directed to related topics affecting the health of actively executing computer applications. In particular, SQL server monitoring, Internet information services monitoring, server monitoring, vulnerability and security update analysis, SQL database free space monitoring, long running agent monitoring and blocking server processes will be discussed. By monitoring aspects of these topics, synergistic interactions result, thereby promoting the health of actively executing computer applications.

SQL Server Monitoring

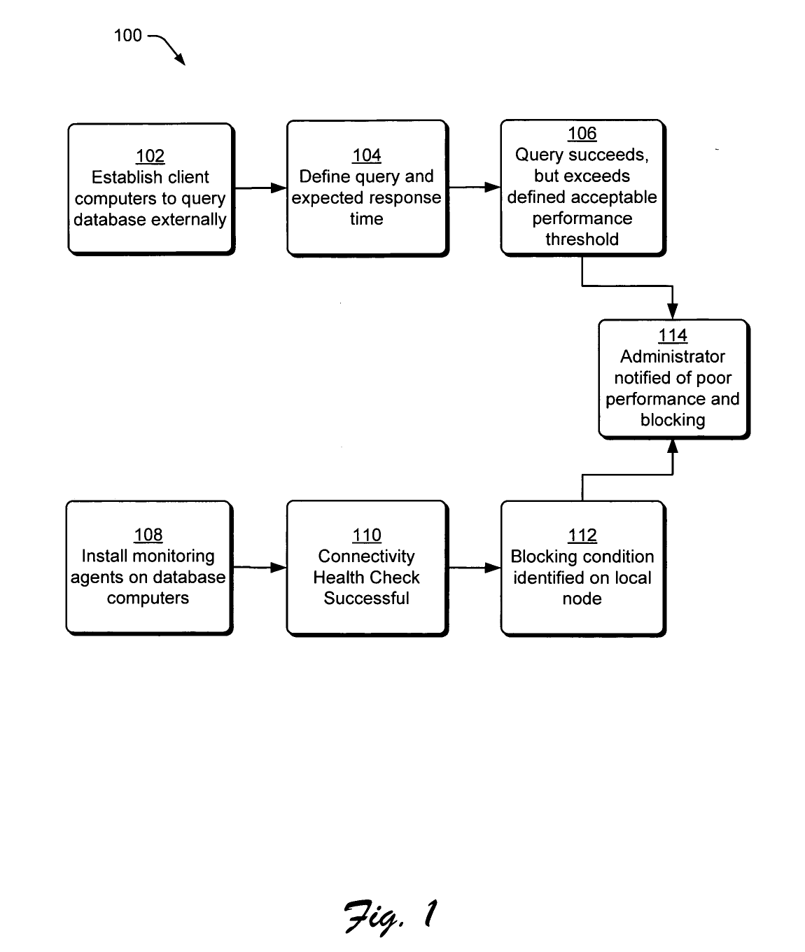

FIG. 1 illustrates exemplary aspects of remote and local monitoring of an operating SQL database. Monitoring systems perform best when combining health checks that are both pro-active and reactive in nature. Pro-active checks are particularly important, since they provide data to an IT administrator prior to service failure or degradation. In contrast, reactive monitoring systems perform health checks on a SQL server (e.g. Microsoft SQL Server 2000) after a problem has occurred. For example, the gathering of data after a problem has occurred is one way that a monitoring system may implement a reactive health check. Thus, collecting events that a SQL server may output when a problem occurs is a method of collecting failure data reactively. Reactive monitoring systems may also perform a basic check on the status of the underlying services being used by a SQL server. Although a partial solution, this approach does not provide a full solution because the administrator will only be aware of a problem once it has occurred, no simulation of the actions of the user or application are performed, and no evaluation of a user experience is performed. Evaluating a simulated user experience, e.g. connecting to the SQL database from outside the data center, is a form of pro-active monitoring that is useful in evaluating responsiveness of the database.

Although a database system may appear healthy when performing basic health checks, it may be performing poorly, either consistently or at inconsistent intervals. A common reason for poor performing of a relational database system is blocking. Blocking occurs when one connection from an application or process holds a lock on a SQL server resource and a second connection requests the same resource. Utilization of the server resources forces the second connection to wait, since it is blocked by the first. In this manner, one connection can block another connection, regardless of whether they originate from the same application or separate applications on different client computers.

Another common reason for poor performance is an agent job that overruns or exceeds a predefined running threshold. A job can perform a wide range of activities, including running Transact-SQL scripts, command line applications, and Microsoft® ActiveX® scripts. Jobs can be scheduled to execute at specific times or recurring intervals. A long running agent job might indicate a potential problem with the SQL server or with the specified SQL server agent job.

Accordingly, it is important for a monitoring systems to pro-actively identify conditions, so that: common user experience problems are identified (e.g. a user querying for data and waiting an unacceptable period of time because of a block); important data uploads are performed within an acceptable period of time, thereby making data available when required (e.g. by the start of business the following day); and data upload or maintenance jobs run during off-peak (non-business) hours to avoid affecting the performance of the database system.

Accordingly, pro-active monitoring of SQL database health is important. In one implementation of these concepts, a Microsoft SQL Server 2000 management pack runs from Microsoft Operations Manager 2005 agents installed on computers that are being monitored. From this agent, the management pack can discover the relevant aspects of Microsoft® SQL Server to be monitored. Prior to performing a health check the management pack can first identify: the components which have been installed by the user which should be monitored; instances of each component that have been installed; prior versions or different SKUs of Microsoft® SQL Server; and the different configuration options of these SKUs such as Named Instances, Cluster Configuration or different roles that an instance is performing (e.g. log shipping, replication etc.).

These concepts are further illustrated by an embodiment where Microsoft SQL Server 2000 MOM management pack performs a multiphase check on a timed basis to inspect the health of Microsoft® SQL Server on a regular basis. By first identifying basic health conditions, it can then simulate the user experience by performing a connection and query, which takes into account the port bindings, connectivity, database health and database engine health. This multiphase check identifies potential issues that a user may experience rather than rely on basic reactive checks looking for failure or error events.

Additionally, the management pack performs health checks from external locations as defined by the administrator, which simulate clients and give the administrator feedback without actual client participation. These external ‘clients’ perform regular actions typical of a user, such as querying the database. This query response time is evaluated, both for successful completion, as well as for responsiveness, to fully understand if Microsoft® SQL Server is healthy, accepting connections and responding in an acceptable manner.

The health of a database system is fundamental to its performance. In a Microsoft®-based implementation of these concepts, a management pack monitors the health of the database system by monitoring for blocking processes. The management pack tracks live running process and watches for blocking conditions. When a blocking condition is identified, the management pack alerts the administrator with information about the blocking condition.

Also, the management pack tracks SQL Server Agent jobs. Running agent jobs are tracked in real time and compared against a predefined acceptable running threshold. Violations of this running threshold are raised in the form of alerts to the administrator with information about the violation and job.

The example of FIG. 1 shows how the management pack may be used to identify issues experienced with Microsoft® SQL Server. In particular, blocks 102-106 show the operation of remote monitoring. At block 102, client computers are established to query the database externally. Accordingly, the client computer simulates the actual clients of the SQL database. At block 104, a query is defined and an expected response time established. In the example of block 106, the query succeeds (i.e. the database returns the appropriate answer) but the time elapsed before return of the answer was unacceptable.

Blocks 108-112 show operation of local monitoring, which when used in combination with remote monitoring, yields a synergistic result. At block 108, monitoring agents are installed on database computers. At block 110, the monitoring agents perform a health check successfully. However, at block 112, blocking conditions are identified on a local node. Accordingly, at block 114, the administrator is notified of the poor performance and blocking. Thus, remote and local monitoring were used together, to provide more information that either would have individually.

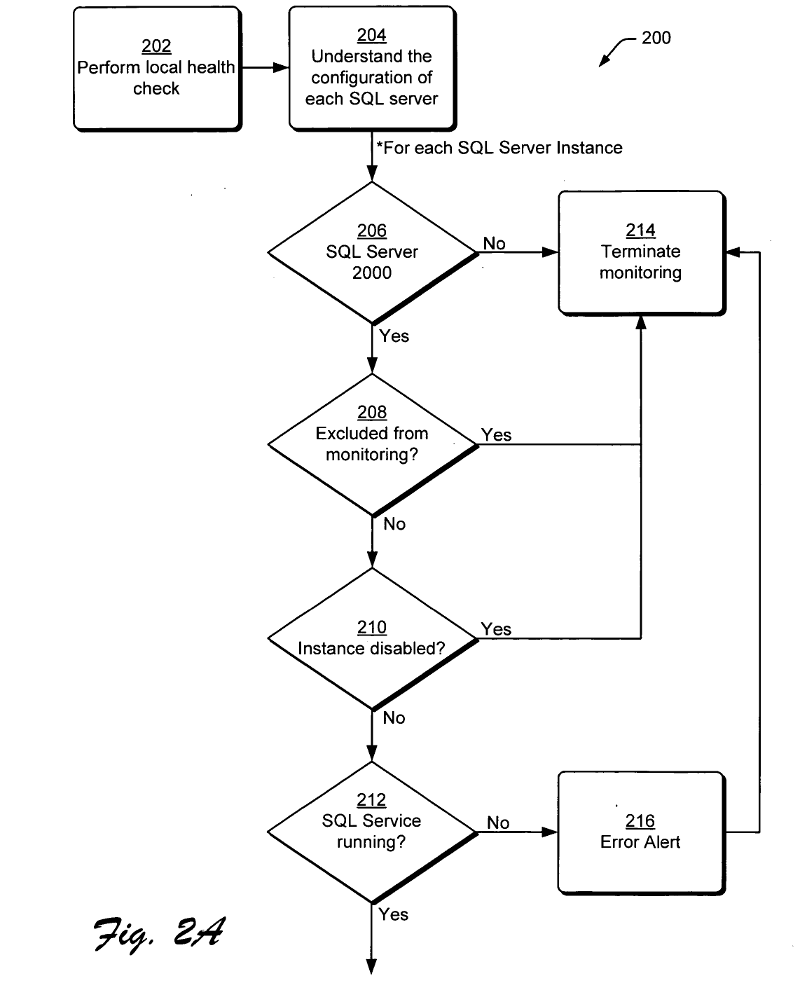

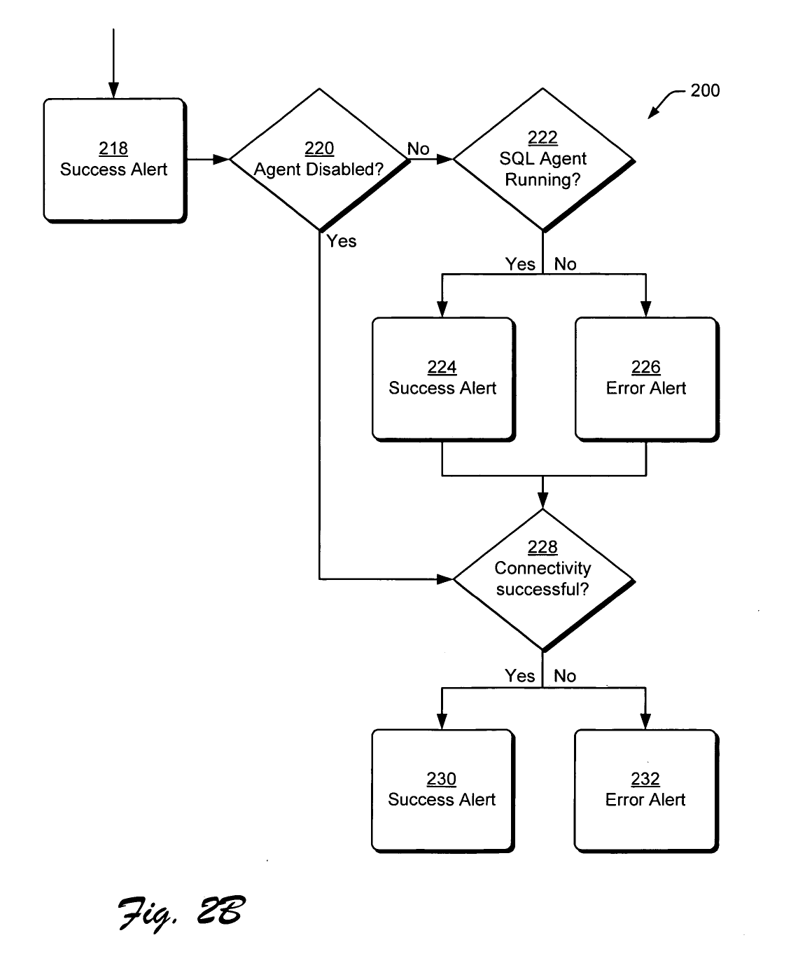

FIGS. 2A and 2B illustrate an example 200 of health checks performed on a SQL server, which for purposes of the example, illustrate a Microsoft®-based environment. At block 202, local health checks are performed on the SQL database. Blocks 108-112 of FIG. 1 illustrate exemplary local health checks, which may employ agents, and may check for connectivity and services running. At block 204, the configuration of each SQL server must be investigated and understood. This is typically performed by inventorying factors associated with the server including: SQL database version; the SKU of SQL Server; how it is configured; and, a purpose for which the server was configured.

At block 206, a loop is entered and repeated for each SQL server instance. At block 206, a check is made for use of SQL server 2000. Naturally, this check could be modified to check for any desired instance or revision thereof. At block 208 a check is made to determine if the instance is to be excluded from monitoring. At block 210, a check is made to determine if the instance is disabled. At block 212, a check is made to determine if the SQL service is running. As seen in FIG. 2A, checks 206-212 may result in a termination of monitoring, at block 214. Additionally, an error alert at block 216 is activated where the SQL service is not running.

Referring to FIG. 2B, block 218 indicates that successful passage of checks 206-212 results in a success alert. At block 220, a check is made to determine if the agent is disabled. Checks are then made to determine if the SQL agent is running (block 222) and if connectivity is successful (block 228). Appropriate alerts 224, 226, 230 and 232 indicate the results of these checks.

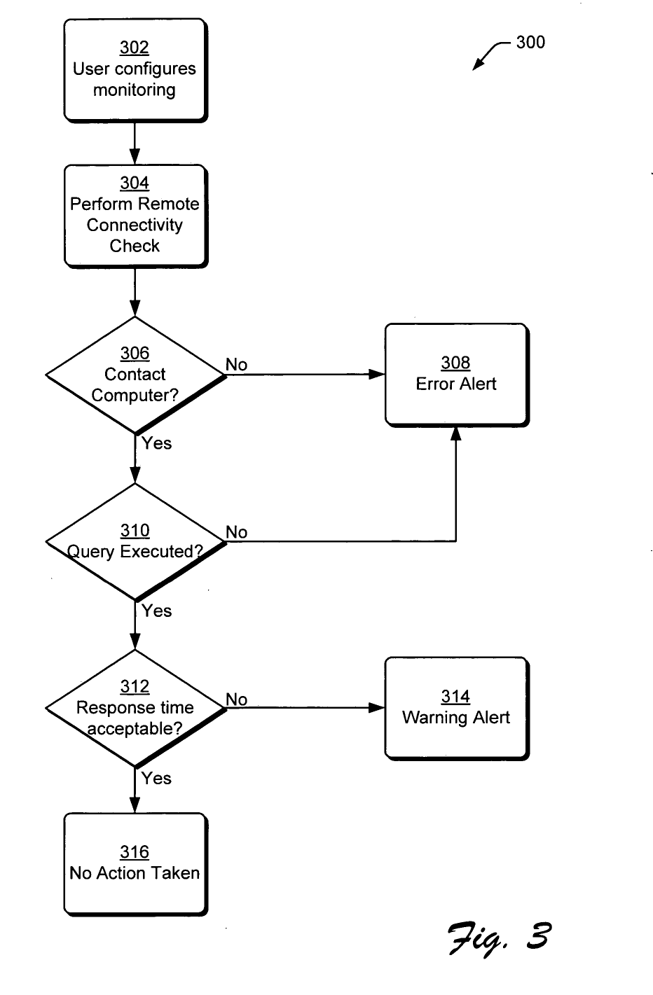

FIG. 3 illustrates an example 300 of a workflow associated with a remote health check. At block 302, the user configures the monitoring. In a exemplary embodiment, the user specifies a database to query, clients to query from (thereby simulating actual clients), and a TSQL statement to execute combined with an expected response time.

At block 304, a remote connectivity check is performed. At block 306, a check is made to determine if contact was made to the computer on which the database is running. If not, an error alert is sounded at block 308. If contact was made, at block 310, a check is made to determine if the query was executed. If not, an error alert is made (block 308). If the query was executed, a check is made at block 312 to determine if the response time was acceptable. If the response time was unacceptable, there is an alert (block 314). If the response time is acceptable, no action is required (block 316).

Internet Information Services Monitoring

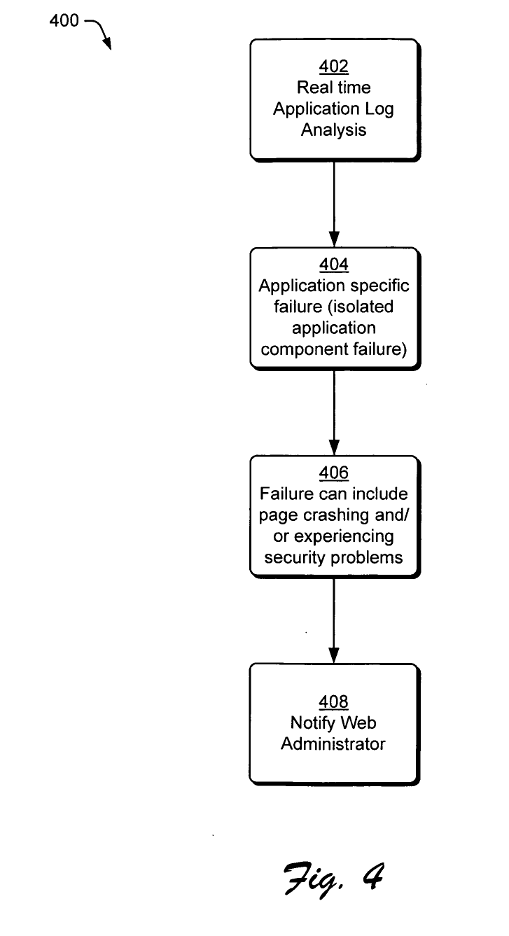

FIG. 4 illustrates an example 400 of Internet information services monitoring employing a multilayered approach to monitoring a web application platform and applications hosted on the platform. In particular, the exemplary monitoring method assesses the availability and health of a Web Application by leveraging the real-time analysis of the Application log, which provides information explaining how the application is reacting to client requests. The method addresses issues such as a web platform that continues to function correctly, even when a client is not be able to access the page due to code defects in the Web Application. Problems like these are detected by real-time analysis of the Application log and by comparison of the log against numerous known failure case scenarios. Additional monitoring sophistication may be added by also monitoring all Internet Information Services web applications logs that are hosted. This provides the web application administrator real time analysis of these logs and notifies the administrator based on comparisons on static criteria that signify potential application failure. Additionally, complex consolidation logic may be used when analyzing the logs to allow detection of internal server errors which results in the web application being unavailable and potentially also affecting other applications hosted in the same Application Pool.

Referring to FIG. 4, a method 400 is illustrated by which real time analysis of the application log may be used to recognize an application specific failure. In particular, at block 402, the application log may be analyzed in real time. As seen above, the analysis may be performed in part by use of complex consolidation logic, which allows detection of internal server errors. This allows an administrator to determine when a web site is unavailable. Real time analysis of the application log automatically detects all web sites and application pools and begins to monitor their service state actively. In addition, some attribute information is collected for use in trouble shooting a web application. At block 404, an application specific failure—such as an isolated application component failure—is recognized. In the example of block 406, the administrator may notice that the same page regularly crashes or otherwise experiences a security problem in a short period. For example, in a Microsoft®-based implementation, login.aspx may be serving up an IIS 500 Error (internal server error) 50 times in 2 minutes. Since none of the other pages is crashing or otherwise experiencing security problems, there is a likelihood that a code defect or dependent resources that login.aspx is unable to handle properly. At block 408 the web administrator is notified.

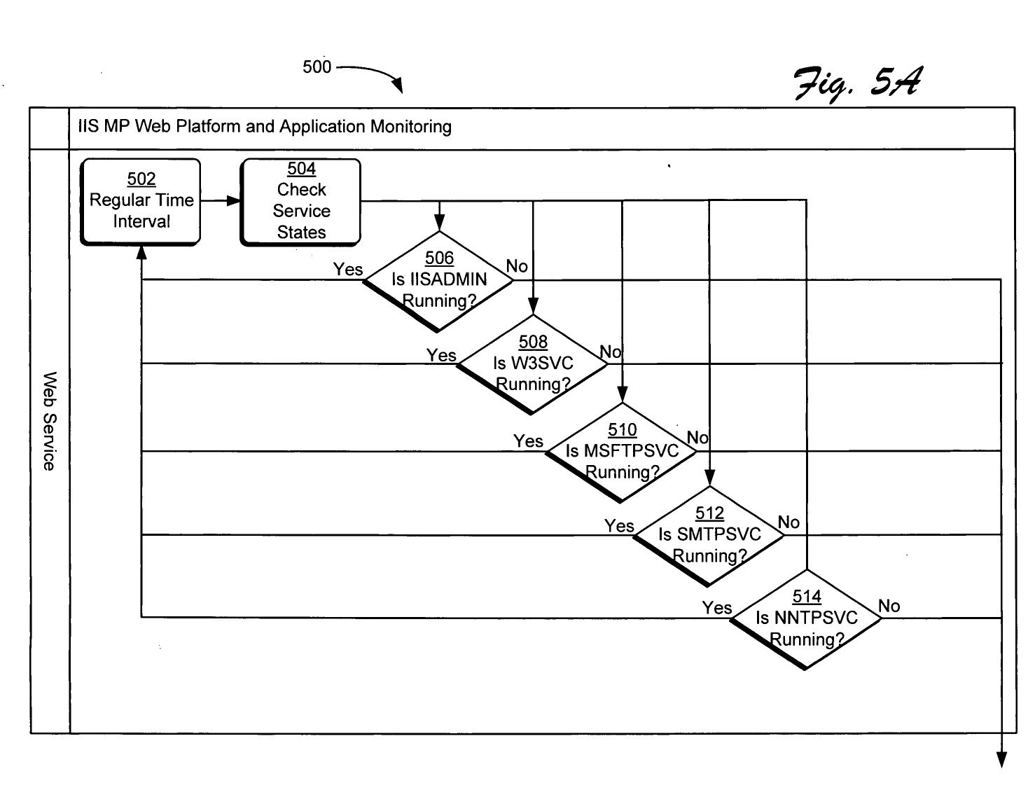

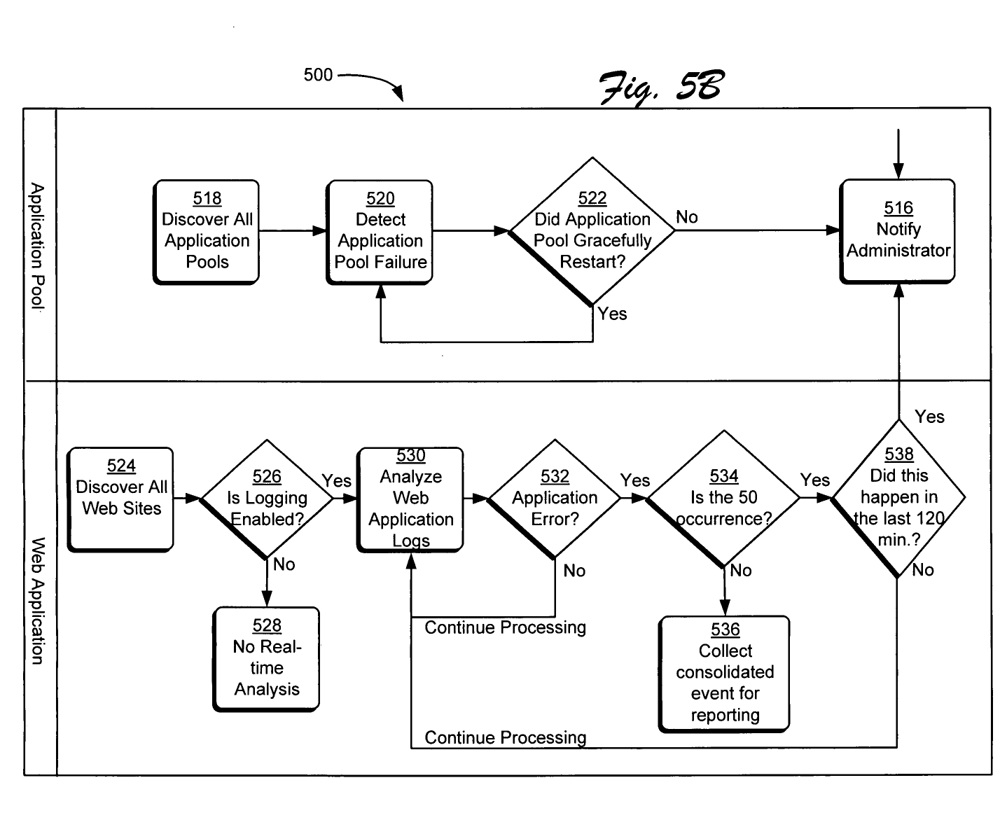

FIGS. 5A and 5B illustrate exemplary aspects 500 associated with web services, application pool and web application monitoring. At block 502, a regular time interval is established by which service states are checked (block 504). Blocks 506-514 establish whether various components within the web service are actively running. If one component is not running the administrator is notified (block 516).

At block 518, all application pools are discovered. Where an application pool failure is detected (block 520) a check is made to determine if the pool restarted gracefully (block 522). If not, the administrator is notified (block 516).

At block 524, all web sites are discovered. At block 526, a check is made to determine if logging is enabled. If not, real time analysis will not be available (block 528). If so, the web application logs are analyzed (block 530). At block 532, a check is made to determine if an application error has occurred. If so, at block 534 a check is made to determine if the error is the 50^{th} occurrence (or other value, depending on the application). If not, at block 536, a consolidated event is collected for reporting. If the error was the 50^{th} occurrence, a check is made at block 538 to determine if the errors resulted in the last 120 minutes (or other selected time period). If so, the administrator is notified (block 516).

Server Monitoring

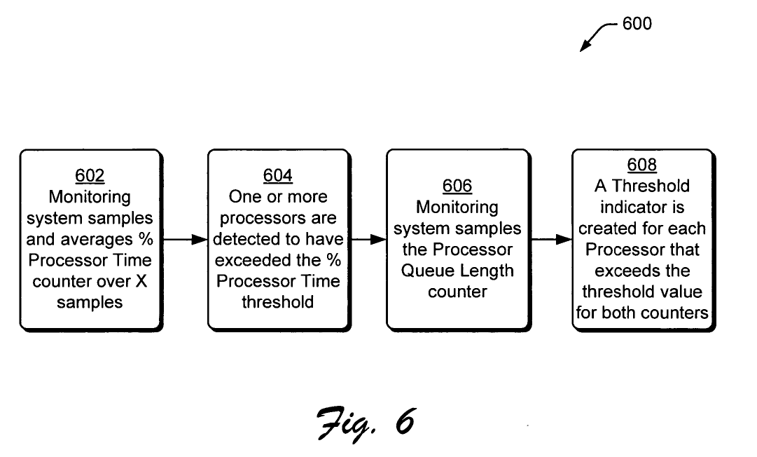

FIG. 6 illustrates an example 600 of processor (CPU) performance threshold monitoring. Monitoring processor (CPU) performance health is a useful tool in monitoring the health of actively executing computer applications. In one embodiment, a monitoring system will sample processor utilization over time and then compare the processors average utilization against a predefined threshold value. A threshold-exceeded indicator will be raised in cases where the average processor utilization exceeds the defined threshold value. While this solution works in some scenarios this approach fails when used with applications that are specifically designed to consume all available processor resources. In these cases, a processor monitoring routine implemented as described above will generate false positives.

In another embodiment, agents may be installed on computers that are being monitored. From these agents, the management pack is able to determine processor (CPU) performance health by sampling each processors “% Processor Time” performance counter over a predefined number of samples (which may be designed to be user configurable).

Once a sufficient number of samples have been collected (another user configurable aspect) an average value for the “% Processor Time” performance counter is calculated for each processor. This average value for each processor is compared against a threshold value (again, user configurable). In the event that the average exceeds the threshold value, a second processor utilization metric will be evaluated. This second metric is the “Processor Queue Length” performance counter. In this case, the “Processor Queue Length” is sampled and if it exceeds the “Processor Queue Length” threshold value (also user configurable) a processor utilization threshold indicator will be created.

Evaluation of these two performance counters enables the monitoring system to dramatically reduce false positive alerts that are often caused by spikes in processor utilization and background processes which do not directly impact core server functionality

FIG. 6 shows an example 600 of how a management pack may be used to identify issues experienced with processor (CPU) performance health. In particular, applications running on servers may put the servers into a processor constrained state. However, regular checks of the processor utilization performance are made by evaluating the % processor time and processor queue length performance counters. In the course of monitoring for processor utilization performance the system may identify that the server has exceeded the processor utilization threshold and create a threshold indicator. If so, the application may require a server with additional processing power. At block 602, a monitoring system samples and averages a % processor time counter over X samples. At block 604, one or more processors are detected to have exceeded the % processor time threshold. At block 606, the monitoring system samples the processor queue length counter. At block 608, a threshold indicator is created for each processor that exceeds the threshold value for both counters.

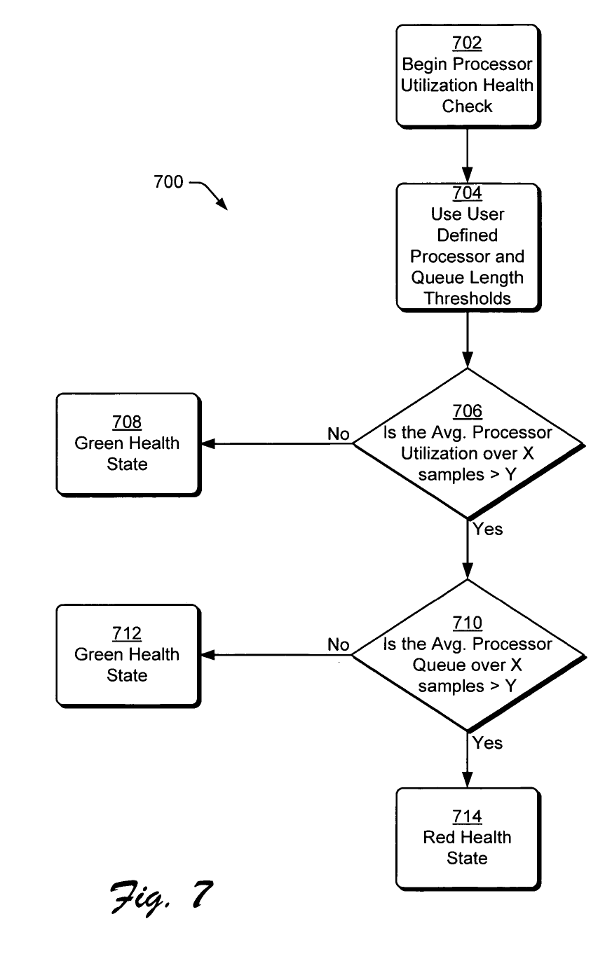

FIG. 7 illustrates a further example 700 of processor (CPU) performance health monitoring. At block 702, a processor utilization health check is begun. At block 704, user-defined processor and queue length thresholds are defined. At block 706, a check is made to determine if the average processor utilization over X samples exceeds Y, where X and Y were set at block 704. Where the processor utilization does not exceed the threshold, a green heal state is confirmed (block 708). Where the threshold is exceeded, at block 710, a check is made to determine if the average processor queue over X samples exceeds Y. If not, the green health state is confirmed (block 712). However, if the average processor queue over X samples exceeds Y, then a red health state is set (block 714).

Vulnerability and Security Update Analysis

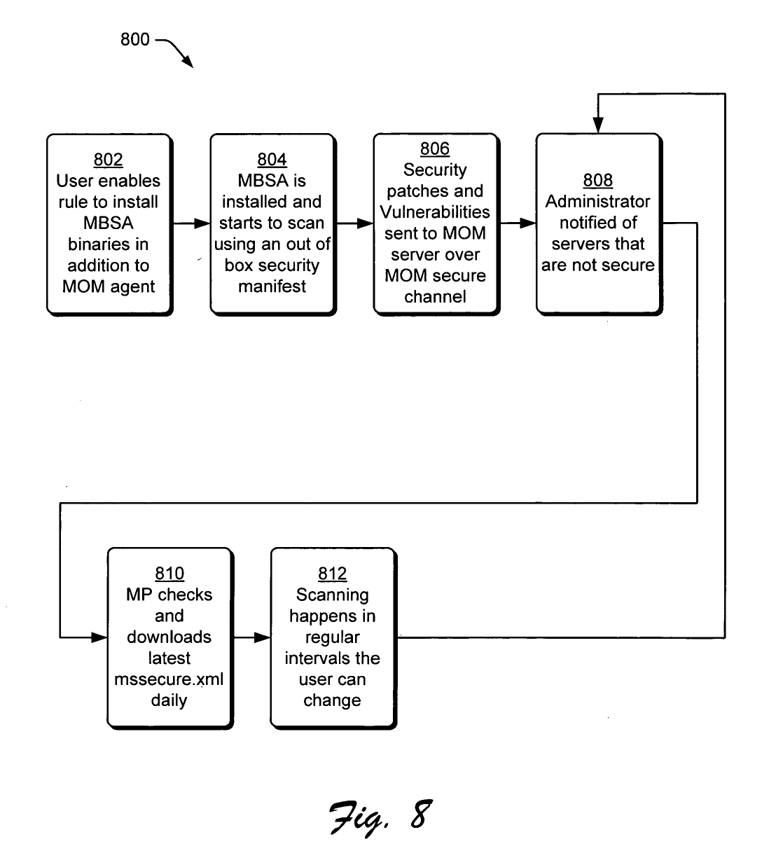

FIG. 8 illustrates an example 800 of installation of a security-scanning engine, distribution of a security manifest and asynchronous scanning. The example 800 is configured to scale well as the number of servers that need to be scanned increases, and is configured to provide functionality even when a firewall is present.

Currently, the common way to alert users about vulnerabilities in the software which are either due to software defects or flaws in the design is some form of public disclosure and bulletin. Most users are able to subscribe to this security bulletin in the form of an email or view them in a browser like: http://www.microsoft.com/security/bulletins/default.mspx.

The following outlines a system and method to monitor the health of Microsoft SQL Server 2000, Internet Information Services, Windows Server, or other server in another environment, and determining the security posture of a managed computer. Accordingly, this system and method provides the following capabilities to alleviate and simplify the administrator's task of scanning servers. First, a distributed install of a security scanning engine is performed. This allows functionality to be provided through firewalls, and is very scalable, as the number of servers increases. Second, the scanning tasks can then be offloaded to the local machine. And third, central reporting the security posture of each managed computer is facilitated by this arrangement. To ensure that the user is able quickly act to any vulnerability detection or security update alert, this configuration provides notification through a response infrastructure as well as viewing the security posture of any given managed computer through an alert or report. This affords the administrator the ability to asynchronously aggregate the security posture of all servers in the environment using an automated regularly scheduled mechanism.

Microsoft® provides an mssecure.xml that is easily downloadable over the Internet, but the burden is still left to the user to distribute or leverage this in their distributed environment to determine the overall security posture of their applications and servers. In addition, although the administrator could configure each machine to access the internet to download this security manifest, in many cases, servers will be isolated in a secure DMZ network that does not have direct access to the internet or an internet proxy server. This results in the additional administrator burden to distribute the security manifest by some other means.

To solve all these problems, the configuration described herein allows an administrator to designate a server as the intermediary file transfer server whose only function is to proxy the mssecure.xml security manifest and nothing else. This provides an in-depth defense by reducing the attack surface of that server, which does not proxy anything else. This configuration therefore allows the agents to automatically detect this file transfer server and download the security manifest from this server.

As vulnerability assessment scanning engines improve, this configuration allows the administrator to leverage newer and updated version of such products by downloading them. This ensures that the administrator can update the scanning engine to leverage new features as well as improvements to the engine itself.

FIG. 8 shows an example 800 of operation of a security scanning engine, distribution of a security manifest, and asynchronous scanning. Accordingly, greater security is provided to a group of servers. At block 802, a user enables a rule to install MBSA (Microsoft® Baseline Security Analyzer) binaries in addition to MOM agent, where MBSA and MOM are Microsoft® products. In a more generic example, a user would enable a rule to install binaries in addition to an agent on a server. At block 804, the binaries are installed and start to scan using an out of box security manifest. At block 806, security patches and vulnerabilities are sent to the agent over a secure channel. At block 808, the administrator is notified of servers that are not secure. At block 810, a management pack checks and downloads the latest mssecure.xml daily. At block 812, scanning is performed at regular intervals which are under the administrator's control.

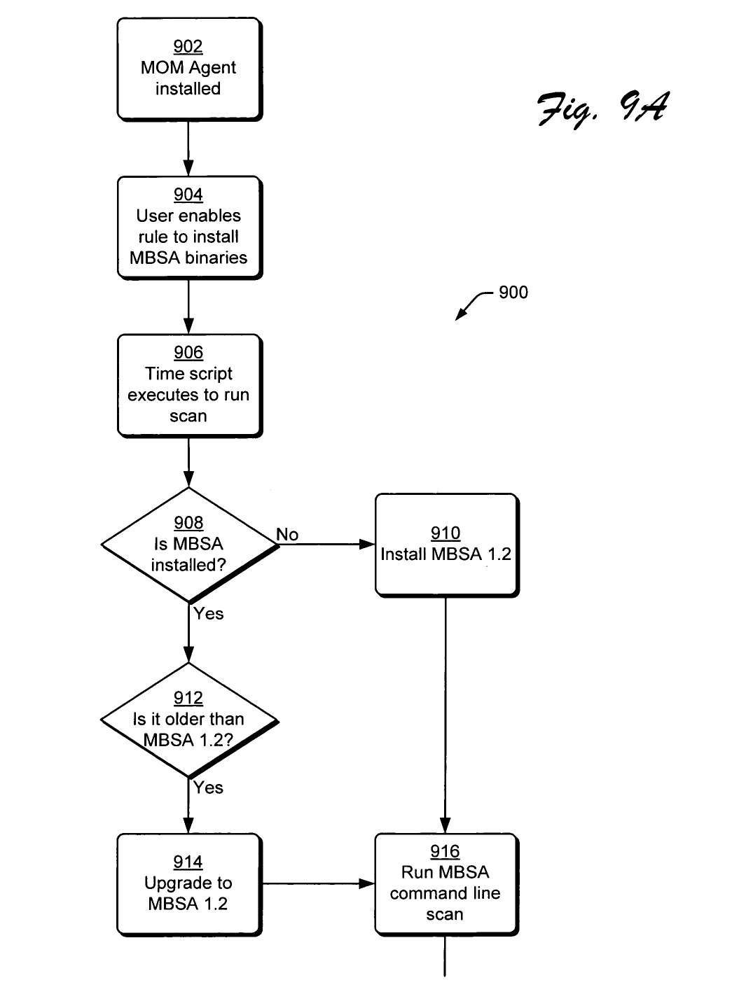

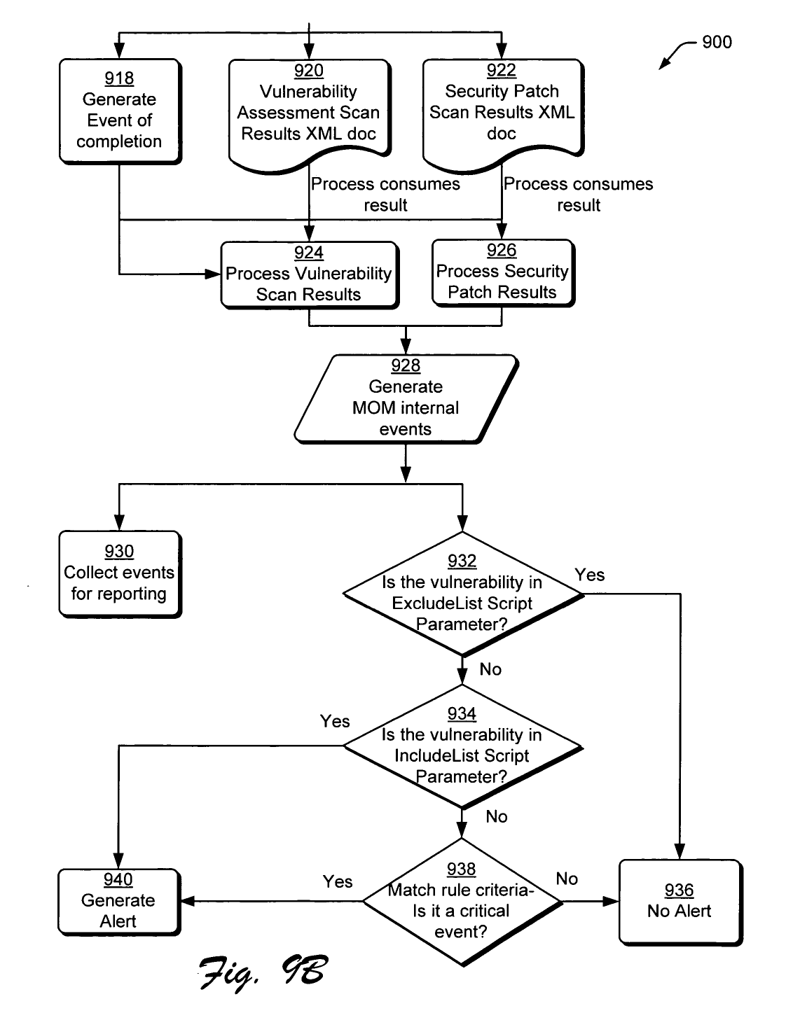

FIGS. 9A and 9B illustrate an example 900 of vulnerability and security update analysis, particularly in a distributed environment using Microsoft® components. By extension, the concepts illustrated could be performed in other environments in a similar manner. At block 902, the MOM (Microsoft® Operations Manager) agent is installed. At block 904, the user enables a rule to install the MBSA binaries. At block 906, a timed script executes, and the scan is run on the server on which the MOM agent and MBSA binaries were installed. At block 908, a check is made to determine if the MBSA binaries were installed (in accordance with the rule set in block 904). If the binaries were not installed, at block 910 they are installed. If they were installed, at block 912 their revision number is checked, and if not the latest, a new upgraded version is installed at block 914. At block 916, the MBSA command line scan is run.

Referring to FIG. 9B, three different results of the command line scan can be seen in blocks 918-922. At block 918, an event of completion is generated. At block 920, the vulnerability assessment scan results in an XML document. At block 922, a security patch scan results in an XML document. At blocks 924 and 916, process vulnerability scan and security patch results are processed. At block 928, MOM internal results are generated. At block 930, events are collected for reporting. At block 932, a check is made to determine if the vulnerability is in the ExcludeList script parameter. If not, at block 934, a check is made to determine if the vulnerability is in the IncludeList script parameter. If so, at block 940 an alert is generated. If not, at block 938 a check is made to determine if match rule criteria is of a critical event. If so, the alert at block 940 is generated. If not, then no alert (block 936) is generated.

SQL Database Free Space Monitoring

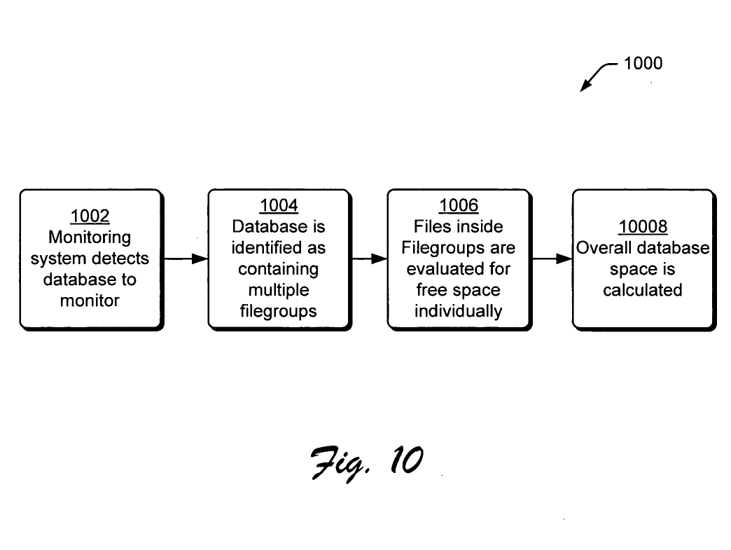

FIG. 10 illustrates a further example 1000 of monitoring relational database free space. At block 1002, a monitoring system detects a database to monitor. At block 1004, the database is identified as containing multiple file groups. At block 1006, files inside file groups are evaluated for free space individually. At block 1008, the overall database space is calculated.

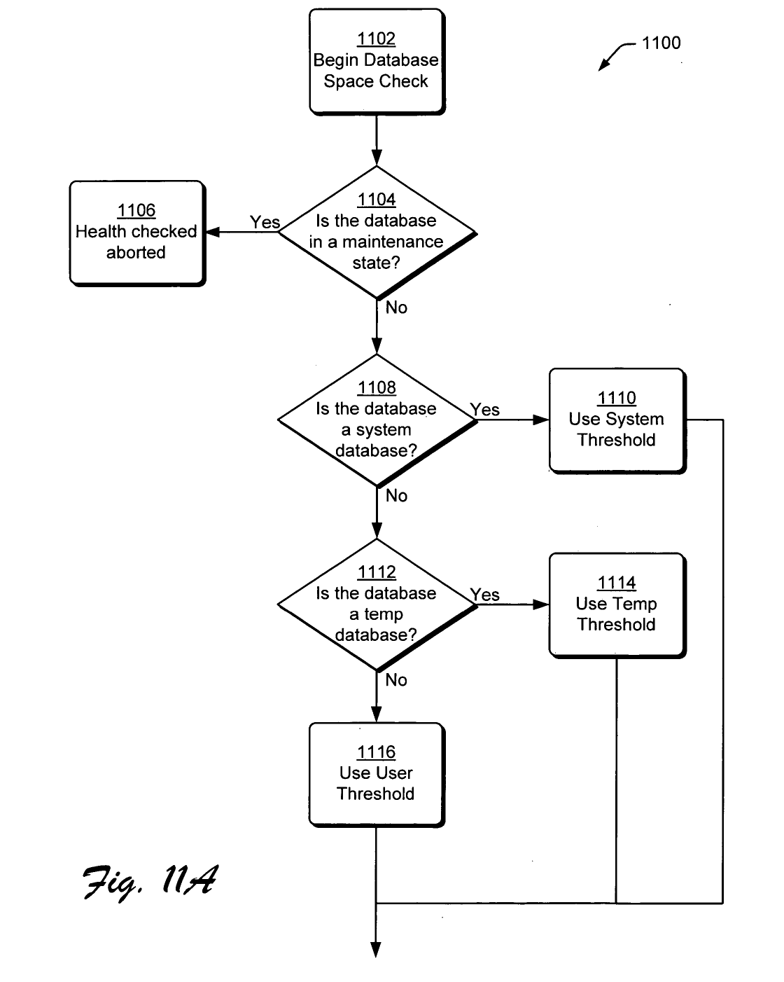

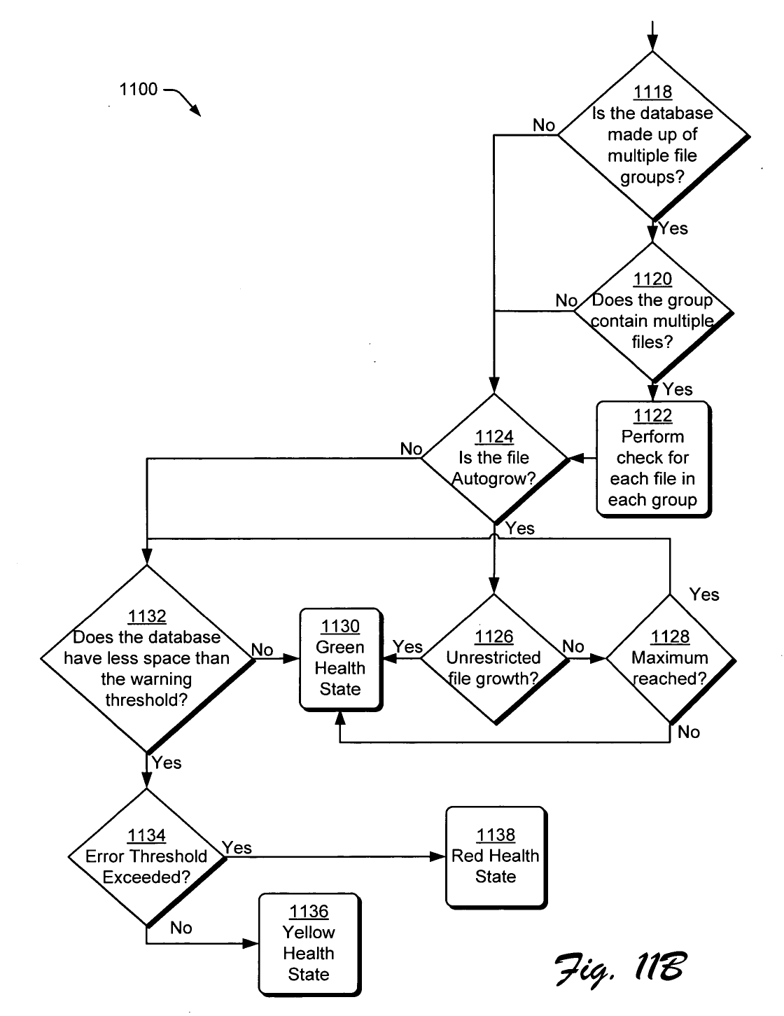

FIGS. 11A and 11B illustrate a more detailed example 1100 of relational database free space monitoring. Free space is an important factor in the health of any database. At block 1102, a database space check is begun. At block 1104, a check is made to determine if the database is in a maintenance state. If so, at block 1106, the health check is aborted. If not, at block 1108, a check is made to determine if the database is a system database. If so, at block 1110, a system threshold is indicated. If not, at block 1112, a check is made to determine of the database is a temporary database. If so, at block 1114, use of a temporary threshold is indicated. If not, at block 1116, use of a user threshold is indicated. At block 1118, a check is made to determine if the database is made up of multiple file groups. If so, at block 1120 a check is made to determine if each of the file groups contains multiple files. If so, at block 1122 a check is performed on each file in each file group. At block 1124, a check is made on each file to determine if it is set to Autogrow. If so, at block 1126, a check is made to determine if the file growth is unrestricted. If not, at block 1128 a check is made to determine if a maximum is reached. If not, at block 1130 the file is listed as having a green health state.

At block 1132, a check is made to determine if the database has less space than the warning threshold (which was set in blocks 1108-1116). If there is more space than the threshold, the database has a green health state (block 1130). Otherwise, at block 1134, a check is made to determine if the error threshold was exceeded. If so, at block 1138 the database has a red health state. If not, at block 1136 the database has a yellow health state.

Long Running Agent Jobs

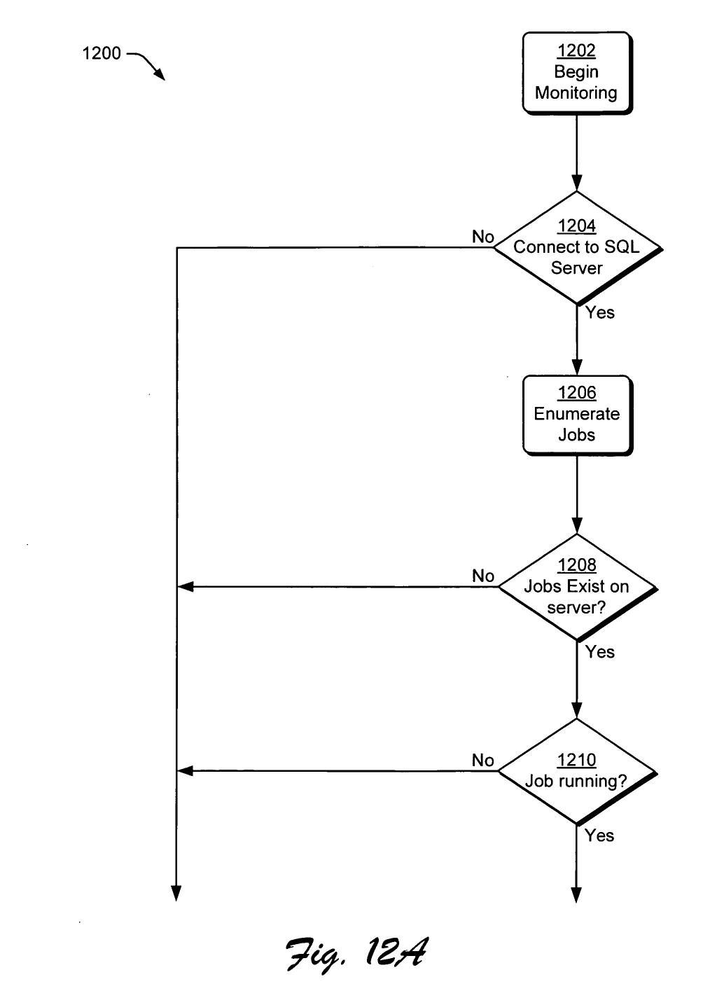

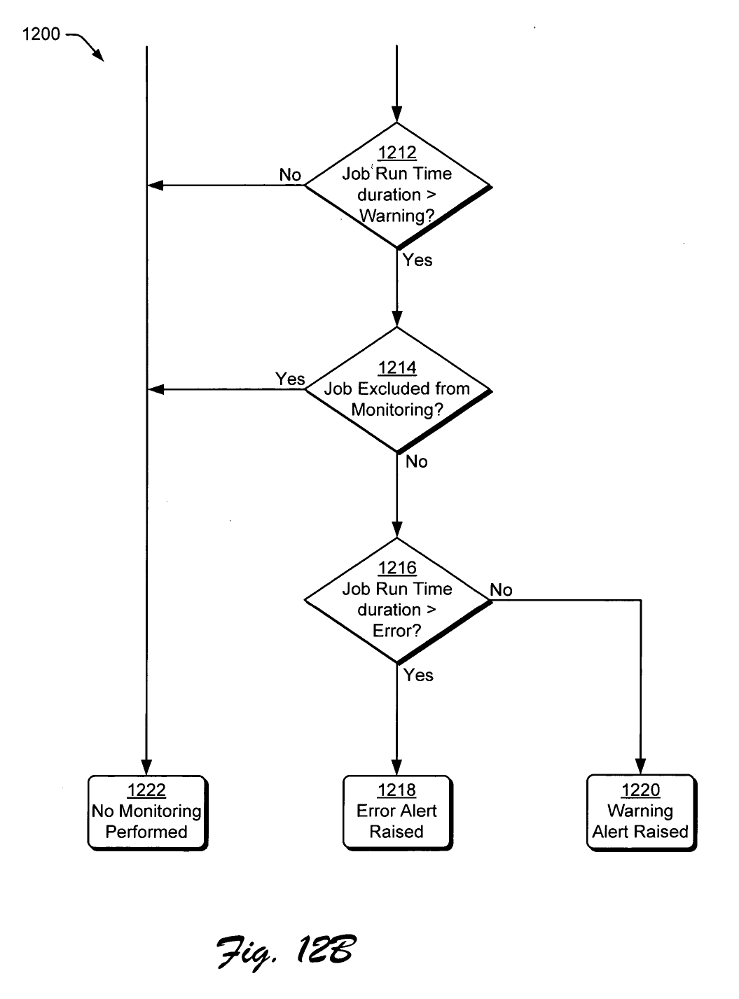

FIGS. 12A and 12B illustrate an example 1200 of long running agent jobs on a SQL server and how they can be monitored. At block 1202, monitoring is begun. At block 1204, a check is made to determine if a connection was made to a SQL server. If so, at block 1206 jobs on the SQL server are enumerated. At block 1208, a check is made to determine if any jobs exist on the server. If so, at block 1210 a check is made to determine if any of the jobs are running. At block 1212, a check is made to determine if the job run time duration has exceeded the warning threshold. If so, at block 1214, a check is made to determine if the job was excluded from monitoring. If not, at block 1216, a check is made to determine if the job run time duration has exceeded the error time. If not, a warning alert is raised (block 1220), and is so, an error alert is raised (block 1218). At block 1222, under conditions wherein monitoring was not warranted, it is not performed.

Blocking Server Process IDs

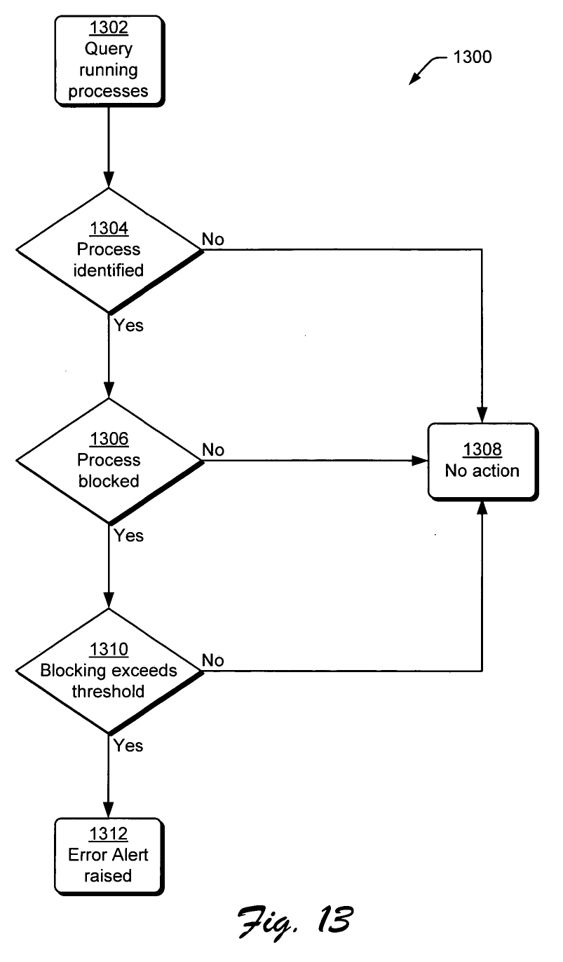

FIG. 13 illustrates an example 1300 of blocking server process IDs. At block 1302, a process by which running process are queried is initiated. At block 1304, a check is made to determine if a process has been identified. If so, a check is made at block 1306 to determine if the process if blocked. If so, a check is made at block 1310 to determine if the blocking exceeds a threshold. If so, at block 1312, an error alert is raised. Under other circumstances, no action is taken (block 1308).

Security Issues

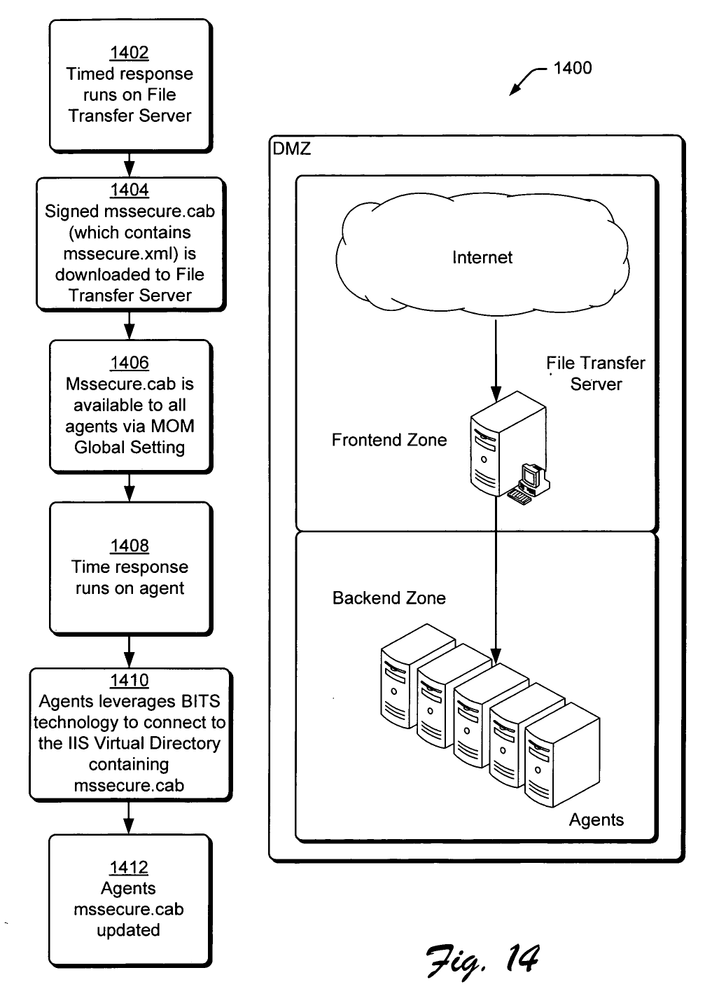

FIG. 14 illustrates an example 1400 wherein a security manifest is distributed. At block 1402, a timed response is run on a file transfer server. At block 1404, a signed mssecure.cab file (which contains mssecure.xml) is downloaded to the file transfer server. Note that while this example is disclosed within the context of a Microsoft® environment, it could similarly be exemplary of other computing environments. At block 1406, mssecure.cab is made available to all agents via MOM (Microsoft® operations management) global settings. At block 1408, a time response runs on the agent. At block 1410, agents leverage BITS technology to connect to the IIS virtual directory containing mssecure.cab. At block 1412, agents' mssecure.cab is updated.

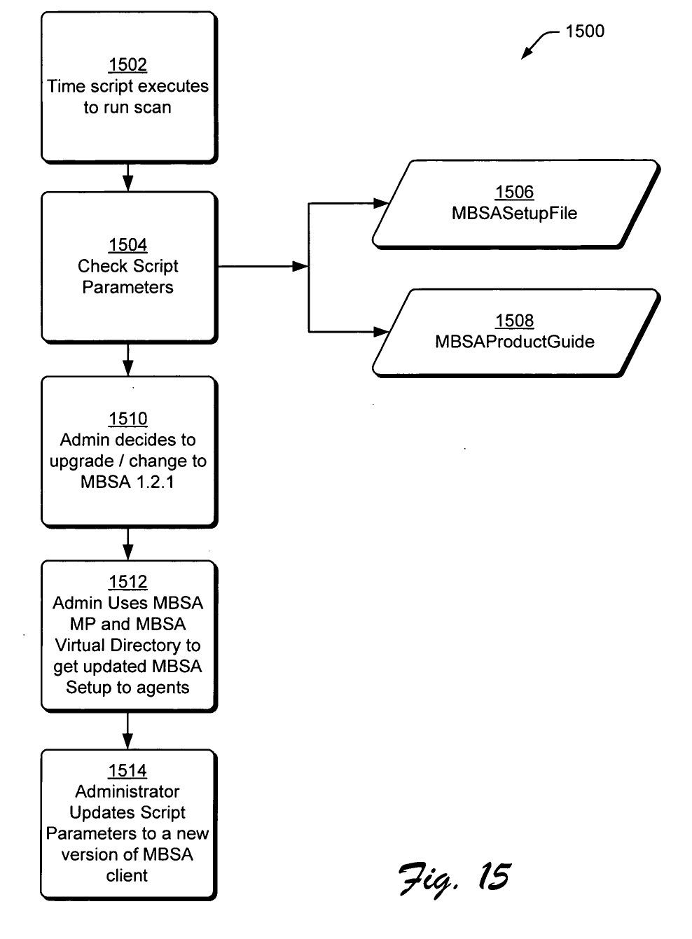

FIG. 15 illustrates an example 1500 of an interchangeable security-scanning engine, configured to allow update to a newer and more compatible scanning engine. At block 1502, a timed script executes to fun a scan. At block 1504, script parameters are checked. This can result in an MBSASetupFile (block 1506) or a MBSAProductGuide (block 1508). At block 1510, the administrator may decide to upgrade and/or change to MBSA 1.2.1. At block 1512, the administrator uses MBSA MP and MBSA virtual directory to get updated MBSA setup to agents. And, at block 1514, the administrator update the Script parameters to new version of the MBSA client.

Exemplary Methods

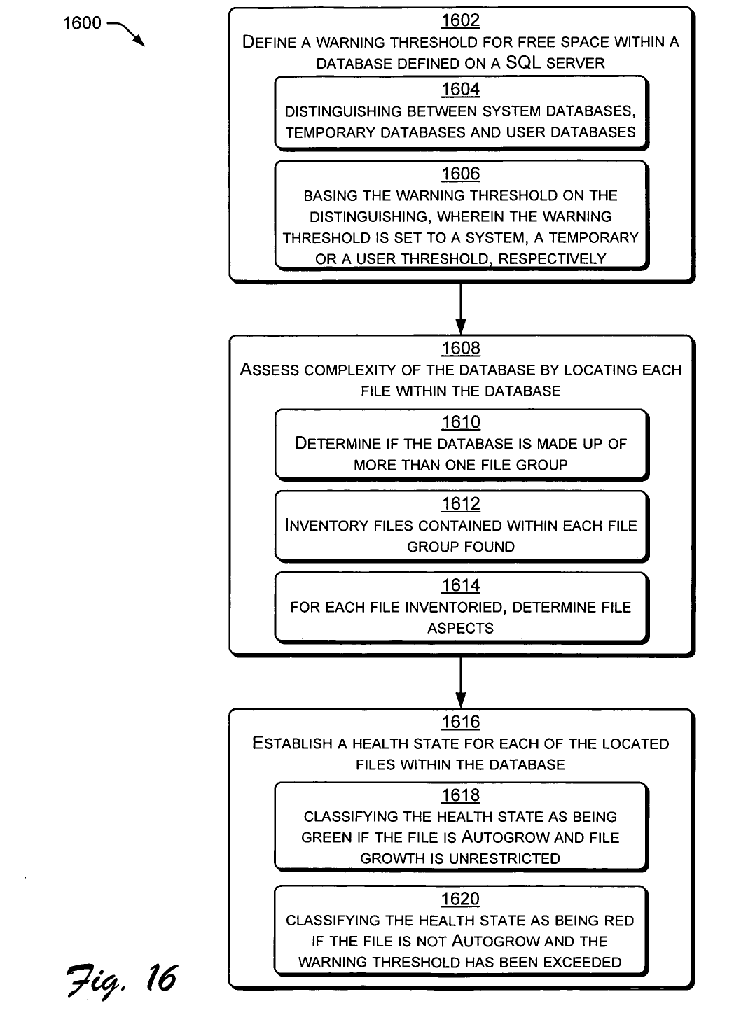

Exemplary methods for implementing aspects of health monitoring for actively executing computer applications will now be described with primary reference to the flow diagrams of FIGS. 16-18. The methods apply generally to the operation of exemplary components discussed above with respect to FIGS. 1-15. The elements of the described methods may be performed by any appropriate means including, for example, hardware logic blocks on an ASIC or by the execution of processor-readable instructions defined on a processor-readable medium. A “processor-readable medium,” as used herein, can be any means that can contain, store, communicate, propagate, or transport instructions for use by or execution by a processor. A processor-readable medium can be, without limitation, an electronic, magnetic, optical, electromagnetic, infrared, or semiconductor system, apparatus, device, or propagation medium. More specific examples of a processor-readable medium include, among others, an electrical connection having one or more wires, a portable computer diskette, a random access memory (RAM), a read-only memory (ROM), an erasable programmable-read-only memory (EPROM or Flash memory), an optical fiber, a rewritable compact disc (CD-RW), and a portable compact disc read-only memory (CDROM).

Referring to FIG. 16, the process 1600 can be implemented in many different computing environments, but will be explained for discussion purposes with respect to SQL server environment of FIGS. 1-15. The process 1600 monitors health of actively executing computer applications, and particularly addresses issues of relational database free space monitoring. At block 1602, a warning threshold is defined to be a minimally acceptable value for a quantity of free space available within a database defined on a SQL server. Blocks 1604 and 1606 of FIG. 16 show one implementation by which the warning threshold may be defined. At block 1604, system databases, temporary databases and user databases are distinguished, thereby allowing imposition of a different warning threshold to these different types of database. Thus, a SQL server is examined, and the databases present are determined to be one of these types of database. At block 1606, the warning threshold is set to a system threshold, a temporary threshold or a user threshold, in response discovery of a system database, a temporary database or a user database, respectively.

At block 1608, the complexity of the database is assessed by locating each file within the database. Blocks 1610-1614 of FIG. 16 show one implementation by which the complexity of the database may be assessed. At block 1610, it is determined whether the database is made up of more than one file group. Because each file group can contain more than one file, at block 1612, an inventory is performed to catalog the files contained within each of the file groups that were found. At block 1614, each file that is inventoried is examined. For example, the size and free space associated with the file is determined, as well as whether the file is allowed to grow (e.g. Autogrow), and if so, a size to which the file is allowed to reach.

At block 1616, a health state is established for each of the files located within the database. Blocks 1618-1620 of FIG. 16 show one implementation by which the state of the health of each file may be established. At block 1618, the health state is classified as being green if the file is configured as Autogrow and the growth is unrestricted. In contrast, at block 1620, the health state of the file is classified as being red if the file is not configured as Autogrow and the warning threshold has been exceeded.

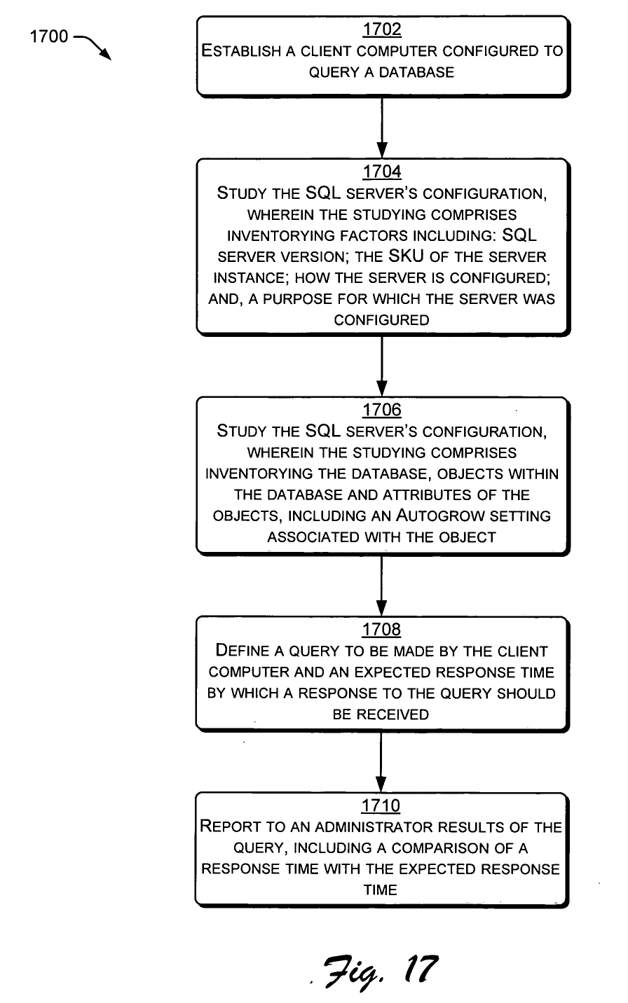

FIG. 17 shows an exemplary method 1700 that monitors health of actively executing computer applications, and particularly addresses issues related to monitoring a SQL server. At block 1702, a client computer is established, and configured to query a database. The client computer is configured in a manner similar to a customer computer, i.e. a user of the SQL server. Accordingly, the client computer experiences any problems encountered by users of the SQL server.

In the embodiment shown at block 1704, the SQL server's configuration is studied. In particular, an inventory is made of factors such as the SQL server version, the SKU of the server instance, how the server is configured, and for what purpose the server was configured.

In the embodiment shown at block 1706, the SQL server's configuration is further studied. In particular, an inventory of the database is performed, wherein files, objects, the attributes of the objects (e.g. an Autogrow setting associated with the object) are all cataloged.

At block 1708, a query is defined that will be made by the client computer to the SQL server. An expected response time is also defined, within which time the SQL server should make a response to the client computer. The expected response time may be based on experience with similar queries and databases.

At block 1710, a report, outlining the results of the query, is made to an administrator. In the embodiment of implementation 1700, the report includes a comparison of an actual response time with the expected response time. Using this information, the administrator is able to determine if the SQL server is performing adequately.

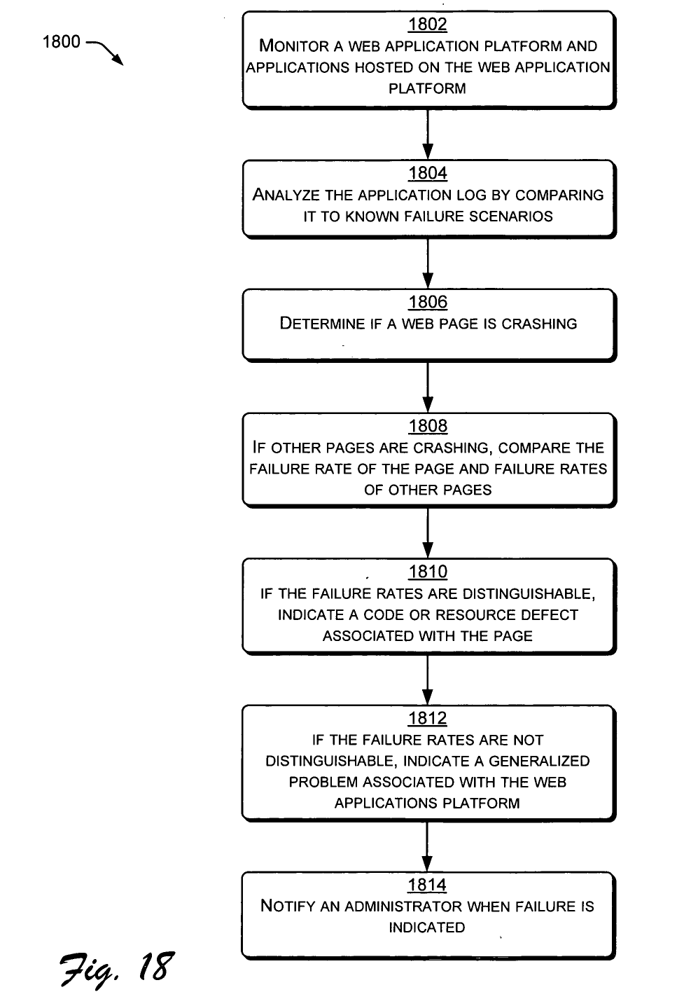

FIG. 18 shows exemplary method 1800 for monitoring health of actively executing computer applications, and particularly addresses monitoring of Internet information services. At block 1802, a web application platform and applications hosed on the web application platform are monitored. The monitoring may provide an application log, which is analyzed at block 1804. In particular, the analysis includes a comparison of entries within the application log to known failure scenarios. For example, a web page crash is a common failure scenario. Therefore, at block 1806, a determination is made if a web page is crashing. At block 1808, if other web pages are crashing, a comparison is made between the failure rate of the initial page and the failure rate of the other web pages. At block 1810, if the failure rates are distinguishable (i.e. significantly different) then an indication is made citing a code or resource defect associated with the page. Alternatively, at block 1812, if the failure rates are not distinguishable, then an indication is made citing a more generalized problem associated with the web applications program is made. At block 1814, an administrator is notified when failure is indicated.

While one or more methods have been disclosed by means of flow diagrams and text associated with the blocks of the flow diagrams, it is to be understood that the blocks do not necessarily have to be performed in the order in which they were presented, and that an alternative order may result in similar advantages. Furthermore, the methods are not exclusive and can be performed alone or in combination with one another.

Exemplary Computer

FIG. 1900 illustrates an exemplary computing environment suitable for implementing a computer or server. Although one specific configuration is shown, other computing configurations could be substituted.

The computing environment 1900 includes a general-purpose computing system in the form of a computer 1902. The components of computer 1902 can include, but are not limited to, one or more processors or processing units 1904, a system memory 1906, and a system bus 1908 that couples various system components including the processor 1904 to the system memory 1906. The system bus 1908 represents one or more of any of several types of bus structures, including a memory bus or memory controller, a peripheral bus, a Peripheral Component Interconnect (PCI) bus, an accelerated graphics port, and a processor or local bus using any of a variety of bus architectures.

Computer 1902 typically includes a variety of computer readable media. Such media can be any available media that is accessible by computer 1902 and includes both volatile and non-volatile media, removable and non-removable media. The system memory 1906 includes computer readable media in the form of volatile memory, such as random access memory (RAM) 1910, and/or non-volatile memory, such as read only memory (ROM) 1912. A basic input/output system (BIOS) 1914, containing the basic routines that help to transfer information between elements within computer 1902, such as during start-up, is stored in ROM 1912. RAM 1910 typically contains data and/or program modules that are immediately accessible to and/or presently operated on by the processing unit 1904.

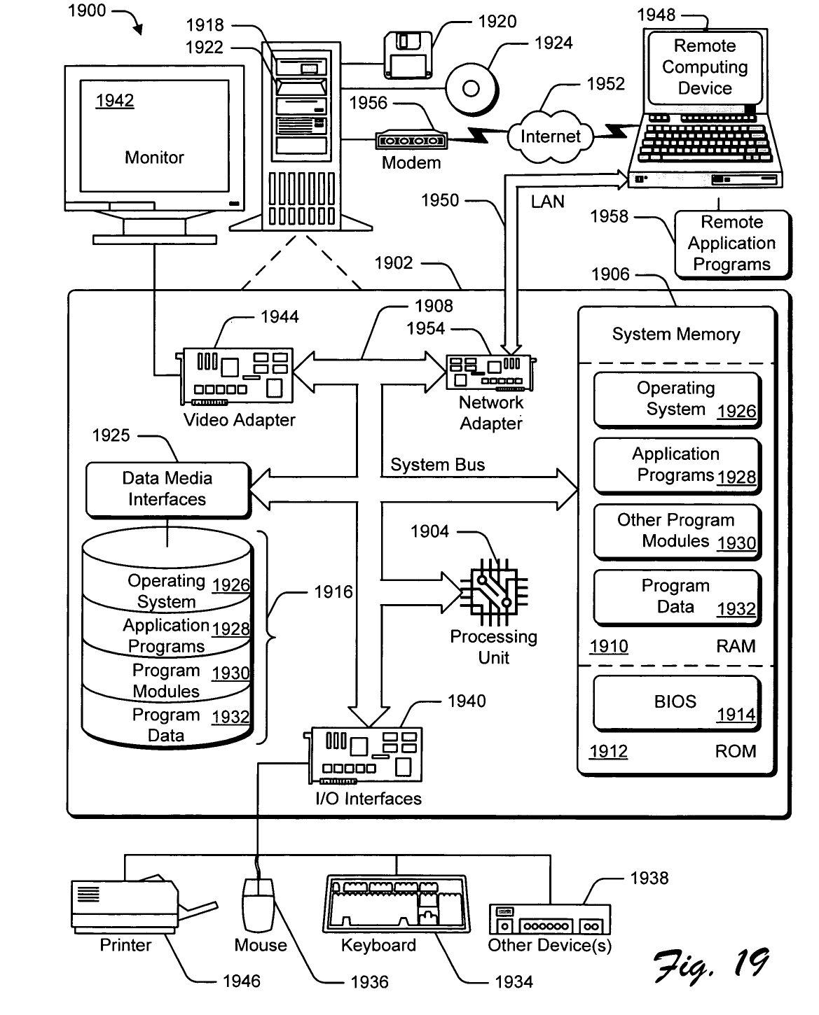

Computer 1902 can also include other removable/non-removable, volatile/non-volatile computer storage media. By way of example, FIG. 19 illustrates a hard disk drive 1916 for reading from and writing to a non-removable, non-volatile magnetic media (not shown), a magnetic disk drive 1918 for reading from and writing to a removable, non-volatile magnetic disk 1920 (e.g., a “floppy disk”), and an optical disk drive 1922 for reading from and/or writing to a removable, non-volatile optical disk 1924 such as a CD-ROM, DVD-ROM, or other optical media. The hard disk drive 1916, magnetic disk drive 1918, and optical disk drive 1922 are each connected to the system bus 1908 by one or more data media interfaces 1925. Alternatively, the hard disk drive 1916, magnetic disk drive 1918, and optical disk drive 1922 can be connected to the system bus 1908 by a SCSI interface (not shown).

The disk drives and their associated computer-readable media provide non-volatile storage of computer readable instructions, data structures, program modules, and other data for computer 1902. Although the example illustrates a hard disk 1916, a removable magnetic disk 1920, and a removable optical disk 1924, it is to be appreciated that other types of computer readable media which can store data that is accessible by a computer, such as magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like, can also be utilized to implement the exemplary computing system and environment.

Any number of program modules can be stored on the hard disk 1916, magnetic disk 1920, optical disk 1924, ROM 1912, and/or RAM 1910, including by way of example, an operating system 1926, one or more application programs 1928, other program modules 1930, and program data 1932. Each of such operating system 1926, one or more application programs 1928, other program modules 1930, and program data 1932 (or some combination thereof) may include an embodiment of a caching scheme for user network access information.

Computer 1902 can include a variety of computer/processor readable media identified as communication media. Communication media typically embodies computer readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above are also included within the scope of computer readable media.

A user can enter commands and information into computer system 1902 via input devices such as a keyboard 1934 and a pointing device 1936 (e.g., a “mouse”). Other input devices 1938 (not shown specifically) may include a microphone, joystick, game pad, satellite dish, serial port, scanner, and/or the like. These and other input devices are connected to the processing unit 1904 via input/output interfaces 1940 that are coupled to the system bus 1908, but may be connected by other interface and bus structures, such as a parallel port, game port, or a universal serial bus (USB).

A monitor 1942 or other type of display device can also be connected to the system bus 1908 via an interface, such as a video adapter 1944. In addition to the monitor 1942, other output peripheral devices can include components such as speakers (not shown) and a printer 1946 that can be connected to computer 1902 via the input/output interfaces 1940.

Computer 1902 can operate in a networked environment using logical connections to one or more remote computers, such as a remote computing device 1948. By way of example, the remote computing device 1948 can be a personal computer, portable computer, a server, a router, a network computer, a peer device or other common network node, and the like. The remote computing device 1948 is illustrated as a portable computer that can include many or all of the elements and features described herein relative to computer system 1902.

Logical connections between computer 1902 and the remote computer 1948 are depicted as a local area network (LAN) 1950 and a general wide area network (WAN) 1952. Such networking environments are commonplace in offices, enterprise-wide computer networks, intranets, and the Internet. When implemented in a LAN networking environment, the computer 1902 is connected to a local network 1950 via a network interface or adapter 1954. When implemented in a WAN networking environment, the computer 1902 typically includes a modem 1956 or other means for establishing communications over the wide network 1952. The modem 1956, which can be internal or external to computer 1902, can be connected to the system bus 1908 via the input/output interfaces 1940 or other appropriate mechanisms. It is to be appreciated that the illustrated network connections are exemplary and that other means of establishing communication link(s) between the computers 1902 and 1948 can be employed.

In a networked environment, such as that illustrated with computing environment 1900, program modules depicted relative to the computer 1902, or portions thereof, may be stored in a remote memory storage device. By way of example, remote application programs 1958 reside on a memory device of remote computer 1948. For purposes of illustration, application programs and other executable program components, such as the operating system, are illustrated herein as discrete blocks, although it is recognized that such programs and components reside at various times in different storage components of the computer system 1902, and are executed by the data processor(s) of the computer.

Conclusion

Although aspects of this disclosure include language specifically describing structural and/or methodological features of preferred embodiments, it is to be understood that the appended claims are not limited to the specific features or acts described. Rather, the specific features and acts are disclosed only as exemplary implementations, and are representative of more general concepts.

1. One or more computer-readable media comprising computer-executable instructions for relational database space monitoring, the computer-executable instructions comprising instructions for:
defining a warning threshold for free space within a database defined on a SQL server;
assessing complexity of the database by locating each file within the database; and
establishing a health state for each of the located files within the database, wherein the health state is based on a comparison of free space in each of the located files to the warning threshold.

2. The one or more computer-readable medium as recited in claim 1, wherein defining a warning threshold comprises instructions for:
distinguishing between system databases, temporary databases and user databases; and
basing the warning threshold on the distinguishing, wherein the warning threshold is set to a system threshold, a temporary threshold or a user threshold, respectively.

3. The one or more computer-readable medium as recited in claim 1, wherein assessing complexity of the database comprises instructions for:
determining if the database is made up of more than one file group;
inventorying files contained within each file group found; and
for each file inventoried, determining a size and free space associated with the file, determining if the file is allowed to grow, and if so, determining a size to which the file is allowed to grow.

4. The one or more computer-readable medium as recited in claim 1, wherein assessing complexity of the server instance comprises instructions for:
inventorying factors associated with the server instance including: SQL server version; the SKU of the server; how the server is configured; and, a purpose for which the server was configured; and
inventorying the server, objects within the server such as databases and attributes of the databases, including an Autogrow setting associated with the objects.

5. The one or more computer-readable medium as recited in claim 1, wherein establishing a health state for each of the located files comprises instructions for:
classifying the health state as being green if the file is Autogrow and file growth is unrestricted; and
classifying the health state as being red if the file is not Autogrow and the warning threshold has been exceeded.

6. One or more computer-readable media comprising computer-executable instructions for monitoring a SQL server, the computer-executable instructions comprising instructions for:
establishing a client computer configured to query a database;
defining a query to be made by the client computer and an expected response time by which a response to the query should be received; and
reporting to an administrator results of the query, including a comparison of the response time with the expected response time.

7. The one or more computer-readable media of claim 6, additionally comprising instructions for:
studying the SQL server instance, wherein the studying comprises inventorying factors including: SQL server version; the SKU of the server; how the server is configured; and, a purpose for which the server was configured.

8. The one or more computer-readable media of claim 6, additionally comprising instructions for:
studying the SQL server's configuration, wherein the studying comprises inventorying the database, objects within the database and attributes of the objects, including an Autogrow setting associated with the object.

9. The one or more computer-readable media of claim 6, additionally comprising instructions for:
studying the SQL server's configuration;
checking to see if a SQL service is running on the SQL server;
checking to see if a SQL agent is running on the SQL server;
checking connectivity of the SQL server; and
providing success alerts to indicate if the SQL service is running, if the SQL agent is running and if the SQL server has connectivity;
wherein the checking is performed on services and agents revealed by the studying.

10. The one or more computer-readable media of claim 6, additionally comprising instructions for:
querying running processes;
identifying running processes that are blocked; and
reporting the blocked processes to an administrator in real time, as the blockage exceeds a threshold.

11. The one or more computer-readable media of claim 6, additionally comprising instructions for:
installing monitoring agents on computers hosting databases;
performing a connectivity check on the computers using the agents; and
identifying blocking conditions using the agents.

12. The one or more computer-readable media of claim 6, additionally comprising instructions for:
enumerating jobs running on the SQL server;
for each job enumerated, comparing job run time to a threshold, thereby identifying long running jobs; and
reporting the long running jobs in real time, prior to job conclusion.

13. The one or more computer-readable media of claim 6, additionally comprising instructions for:
installing security scanning engines in a distributed manner over a plurality of servers;
scanning each of the plurality of servers using the security scanning engine distributed to that server; and
reporting a security posture of each of the plurality of servers to the administrator.

14. The one or more computer-readable media of claim 6, additionally comprising instructions for:
defining processor and queue length thresholds;
comparing average processor utilization and average processor queue to the processor and queue length thresholds; and
assigning a health state to processor utilization based on the comparison.

15. One or more computer-readable media comprising computer-executable instructions for monitoring internet information services, the computer-executable instructions comprising instructions for:
monitoring a web application platform and applications hosted on the web application platform, wherein the monitoring produces an applications log comprising data generated during operation of the applications;
analyzing the application log by comparing it to known failure scenarios; and
notifying an administrator when failure is indicated.

16. The one or more computer-readable media of claim 15, wherein monitoring the web application platform and applications comprises instructions for:
automatically detecting all web sites and application pools;
monitoring a service state of the web sites and application pools; and
collecting attribute information on the web sites and application pools.

17. The one or more computer-readable media of claim 15, wherein comparing the application log to known failure scenarios comprises instructions for:
monitoring a page from among the web sites;
noting a failure rate in crashes per unit time of the page; and
comparing the crashes per unit time to a threshold.

18. The one or more computer-readable media of claim 15, wherein notifying the administrator when failure is indicated comprises instructions for:
performing the monitoring and the analyzing in a continuous manner; and
notifying the administrator in real time, based on contemporaneous results of the monitoring and the analyzing.

19. The one or more computer-readable media of claim 17, additionally comprising instructions for:
determining if other pages are crashing;
if other pages are crashing, comparing the failure rate of the page and failure rates of other pages;
if the failure rates are distinguishable, indicating a code or resource defect associated with the page; and
if the failure rates are not distinguishable, indicating a generalized problem associated with the web applications platform.

20. The one or more computer-readable media of claim 15, additionally comprising instructions for:
discovery of all web sites and application pools within the web application platform;
evaluation of web services within the web application platform at regular intervals; and
notifying the administrator when a web service is not running, or when an application pool fails to gracefully restart, or when an error rate of a web application exceeds a threshold.
